(19) United States
(12) Patent Application Publication
(10) Pub. No.: US 2006/0183022 A1
(43) Pub. Date: Aug. 17, 2006

(54) Electrochemical cell

(76) Inventors: Naoki Takahashi, Miyagi (JP); Tomoki Nobuta, Miyagi (JP); Tetsuya Yoshinari, Miyagi (JP); Takashi Mizukoshi, Miyagi (JP); Toshihiko Nishiyama, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/352,613

(22) Filed: Feb. 13, 2006

(30) Foreign Application Priority Data
Feb. 14, 2005 (JP) 2005-036063

(51) Int. Cl. H01M 4/60

(52) U.S. Cl. 429/213

(57) ABSTRACT

An objective of this invention is to provide an electrochemical cell exhibiting excellent cycle properties at a high temperature. There is provided an electrochemical cell, comprising a polycarbazole compound prepared by polymerizing carbazole or its derivative as an electrode active material, wherein protons act as a charge carrier.

### BACKGROUND OF THE INVENTION

1. Field of the Invention

This invention relates to an electrochemical cell such as a secondary battery and an electric double-layer capacitor; in particular, to an electrochemical cell in which protons act as a charge carrier.

2. Description of the Prior Art

As an electrochemical cell involving protons as a charge carrier, there have been suggested and practically used electrochemical cells such as secondary batteries and electric double-layer capacitors where a proton-conducting compound is used as an electrode active material.

Such an electrochemical cell has a configuration, for example, as shown in the cross-sectional view of FIG. 1, where a cathode collector 1 on which a cathode 2 containing a proton-conducting compound as an active material is formed is laminated with an anode collector 4 on which an anode 3 containing a proton-conducting compound as an active material is formed, via a separator 5 such that the cathode 2 and the anode 3 face each other. Furthermore, an aqueous or non-aqueous solution containing a proton source as an electrolyte solution fills the insides of the separator 5, the cathode 2 and the anode 3, whose outer edges are sealed by a gasket 6.

The cathode 2 and the anode 3 are generally prepared by mixing a doped or undoped proton-conducting compound powder as an electrode active material and, if needed, a conduction auxiliary and a binder and pressing the mixture.

Examples of a conventional electrode active material for an electrochemical cell involving protons as a charge carrier include π-conjugated polymers such as polyaniline, polythiophene, polypyrrole, polyacetylene, poly-p-phenylene, polyphenylene-vinylene, polyperinaphthalene, polyfuran, polyflurane, polythienylene, polypyridinediyl, polyisothianaphthene, polyquinoxaline, polypyridine, polypyrimidine, polyindole, indole derivatives including an indole trimer, polyaminoanthraquinone, polyimidazole and their derivatives; hydroxyl-containing polymers such as polyanthraquinone and polybenzoquinone, of which a quinone oxygen has been converted into a hydroxyl group by conjugation; and proton-conducting polymers prepared by copolymerization of two or more monomers. For example, Japanese Patent Application Laid-open No. 2004-55240-A has described a secondary battery and a capacitor in which an indole trimer is used and protons act as a charge carrier.

Although being not for an electrochemical cell involving protons as a charge carrier, Japanese Examined Patent Publication No. 6-30255-B has described a secondary battery in which a salt-type polycarbazole hydrochloride is used as an electrode active material and an electrolyte.

### SUMMARY OF THE INVENTION

Japanese Patent Application Laid-open No. 2004-55240-A has described that an indole compound such as an indole trimer can be used to provide an electrochemical cell exhibiting excellent properties such as an electromotive force, a capacity and cycle properties. However, such a cell sometimes exhibits inadequate cycle properties at a high temperature. The salt-type polycarbazole described in Japanese Examined Patent Publication No. 6-30255-B expresses the properties of both an electrode active material and an electrolyte. The electrode active material for a secondary battery must be soluble in a solvent (water described in Japanese Examined Patent Publication No. 6-30255-B), while a compound insoluble in a solvent is used as an electrode active material in an electrochemical cell involving protons as a charge carrier. Therefore, it may be difficult to apply a salt-type polycarbazole to the electrochemical cell.

In view of the above problems, an objective of this invention is to provide an electrochemical cell exhibiting excellent cycle properties at a high temperature.

An electrochemical cell according to this invention is an electrochemical cell comprising a polycarbazole compound prepared by polymerizing carbazole or its derivative as an electrode active material, wherein protons act as an charge carrier.

When applying a polycarbazole compound prepared by polymerizing carbazole or its derivative as an electrode active material used in an electrode in an electrochemical cell in which protons act as a charge carrier, thermal stability of the electrode active material is, as a first effect, improved, resulting in improvement in cycle properties of the electrochemical cell at a high temperature. Generally, at a high temperature, an electrode active material tends to be cycle-deteriorated because exothermic heat generated in a micro-region due to current flow in the electrode active material accelerates decomposition of the electrode active material. In contrast, the configuration of this invention is more tolerant to the exothermic heat in a micro-region. As a second effect, since the polycarbazole compound used as an electrode active material is a polymeric compound, the electrode active material is less soluble in an electrolyte solution even at a high temperature, resulting in improved cycle properties at a high temperature.

This invention can provide an electrochemical cell exhibiting excellent cycle properties at a high temperature.

### BRIEF DESCRIPTION OF THE DRAWINGS

FIG. 1 is a schematic cross-sectional view illustrating a configuration of an electrochemical cell according to an embodiment of this invention.

FIG. 2 shows the thermogravimetry results for the compounds prepared in Example 1 and Comparative Example 1.

In these drawings, the symbols have the following meanings; 1: cathode collector, 2: cathode, 3: anode, 4: anode collector, 5: separator; and 6: gasket.

### DETAILED DESCRIPTION OF PREFERRED EMBODIMENTS

An electrochemical cell according to this invention comprises a polycarbazole compound prepared by polymerizing carbazole or its derivative as an electrode active material.

The polycarbazole compound can be prepared by polymerizing carbazole or its derivative as a starting monomer. Since polymerization of carbazoie or its derivative generally provides a polymer compound in which the carbazole or its derivative are mutually linked at 3- and 6-positions, a monomer used is preferably carbazole or its derivative represented by formula (1m):

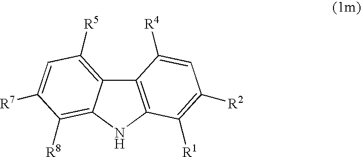

wherein R¹, R², R⁴, R⁵, R⁷ and R⁸ are independently selected from the group consisting of hydrogen, halogen, hydroxyl, carboxyl, sulfonic, nitro, cyano, alkyl, aryl, alkoxy, amino, alkylthio and arylthio. Preferably, R¹, R², R⁴, R⁵, R⁷ and R⁸ are independently selected from the group consisting of carboxyl, cyano and halogen. The alkyl and the alkyl in alkoxy or alkylthio may be selected from, for example, alkyls having 1 to 6 carbon atoms. The aryl and the aryl in arylthio may be selected from, for example, aryls having 6 to 12 carbon atoms. The alkyl and the moiety other than a benzene ring in the aryl may be linear, branched or cyclic.

Examples of the carbazole or its derivative represented by formula (1m) may include:

carbazole;

carbazole derivatives whose hydrogen at 2-position is replaced with a substituent such as 2-methylcarbazole, 2-ethylcarbazole, 2-propylcarbazole, 2-nitrocarbazole, 2-cyanocarbazole, 2-acetylcarbazole, 2-carboxylic-carbazole, 2-methoxycarbonyl-carbazole, 2-ethoxycarbonyl-carbazole, 2-chlorocarbazole, 2-bromocarbazole, 2-hydroxylcarbazole, 2-sulfonic-carbazole, 2-methoxycarbazole and 2-ethoxycarbazole;

carbazole derivatives whose hydrogen at 4-position is replaced with a substituent such as 4-methylcarbazole, 4-ethylcarbazole, 4-propylcarbazole, 4-nitrocarbazole, 4-cyanocarbazole, 4-acetylcarbazole, 4-carboxylic-carbazole, 4-methoxycarbonyl-carbazole, 4-ethoxycarbonyl-carbazole, 4-chlorocarbazole, 4-bromocarbazole, 4-hydroxylcarbazole, 4-sulfonic-carbazole, 4-methoxycarbazole and 4-ethoxycarbazole;

carbazole derivatives whose hydrogens at 2- and 7-positions are replaced with an identical substituent such as 2,7-dimethylcarbazole, 2,7-diethylcarbazole, 2,7-dipropylcarbazole, 2,7-dinitrocarbazole, 2,7-dicyanocarbazole, 2,7-diacetylcarbazole, 2,7-dicarboxylic-carbazole, 2,7-di(methoxycarbonyl)-carbazole, 2,7-di(ethoxycarbonyl)-carbazole, 2,7-dichlorocarbazole, 2,7-dibromocarbazole, 2,7-dihydroxycarbazole, 2,7-disulfonic-carbazole, 2,7-dimethoxycarbazole and 2,7-diethoxycarbazole;

carbazole derivatives whose hydrogens at 4- and 5-positions are replaced with an identical substituent such as 4,5-dimethylcarbazole, 4,5-diethylcarbazole, 4,5-dipropylcarbazole, 4,5-dinitrocarbazole, 4,5-dicyanocarbazole, 4,5-diacetylcarbazole, 4,5-dicarboxylic-carbazole, 4,5-di(methoxycarbonyl)-carbazole, 4,5-di(ethoxycarbonyl)-carbazole, 4,5-dichlorocarbazole, 4,5-dibromocarbazole, 4,5-dihydroxycarbazole, 4,5-disulfonic-carbazole, 4,5-dimethoxycarbazole and 4,5-diethoxycarbazole;

carbazole derivatives whose hydrogens at 2- and 7-positions are replaced with different substituents such as 2-methyl-7-ethylcarbazole, 2-methyl-7-propylcarbazole, 2-methyl-7-cyanocarbazole, 2-methyl-7-nitrocarbazole, 2-methyl-7-carboxylic-carbazole, 2-methyl-7-chlorocarbazole, 2-methyl-7-bromocarbazole, 2-methyl-7-hydroxycarbazole, 2-methyl-7-methoxycarbonyl-carbazole, 2-methyl-7-ethoxycarbonyl-carbazole, 2-methyl-7-sulfonic-rbazole and 2-methyl-7-methoxycarbazole; and

carbazole derivatives whose hydrogens at 4- and 5-positions are replaced with different substituents such as 4-methyl-5-ethylcarbazole, 4-methyl-5-propylcarbazole, 4-methyl-5-cyanocarbazole, 4-methyl-5-nitrocarbazole, 4-methyl-5-carboxylic-carbazole, 4-methyl-5-chlorocarbazole, 4-methyl-5-bromocarbazole, 4-methyl-5-hydroxycarbazole, 4-methyl-5-methoxycarbonyl-carbazole, 4-methyl-5-ethoxycarbonyl-carbazole, 4-methyl-5-sulfonic-carbazole and 4-methyl-5-methoxycarbazole. One or more appropriately selected from carbazole or its derivatives described above can be polymerized to prepare a polycarbazole compound.

Unit structures in a polycarbazole compound obtained are generally linked in a head-to-tail type, but may be linked in a head-to-head or tail-to-tail type.

A polycarbazole compound used in this invention is prepared by polymerizing carbazole or its derivative. For example, polymerization of carbazole or its derivative represented by formula (1m) provides a polycarbazole compound having a unit structure represented by formula (1):

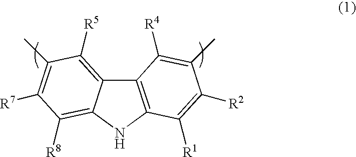

wherein R¹, R², R⁴, R⁵, R⁷ and R⁸ are independently selected from the group consisting of hydrogen, halogen, hydroxyl, carboxyl, sulfonic, nitro, cyano, alkyl, aryl, alkoxy, amino, alkylthio and arylthio. Preferably, R¹, R², R⁴, R⁵, R⁷ and R⁸ are independently selected from the group consisting of carboxyl, cyano and halogen. The alkyl and the alkyl in alkoxy or alkylthio may be selected from, for example, alkyls having 1 to 6 carbon atoms. The aryl and the aryl in arylthio may be selected from, for example, aryls having 6 to 12 carbon atoms. The alkyl and the moiety other than a benzene ring in the aryl may be linear, branched or cyclic.

In this invention, it is preferable to use a polycarbazole compound having a unit structure represented by formula (2) or (3), and it is more preferable to use a polycarbazole compound having two or more of the unit structures represented by formula (2) or (3):

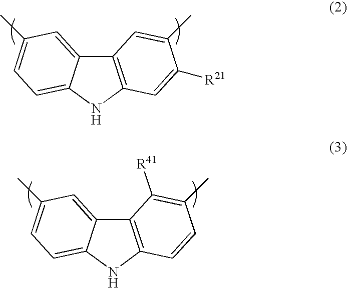

wherein R²¹ and R⁴¹ are independently selected from the group consisting of halogen, hydroxyl, carboxyl, sulfonic, nitro, cyano, alkyl, aryl, alkoxy, amino, alkylthio and arylthio. Preferably, R²¹ and R⁴¹ are independently selected from the group consisting of carboxyl, cyano and halogen. The alkyl and the alkyl in alkoxy or alkylthio may be selected from, for example, alkyls having 1 to 6 carbon atoms. The aryl and the aryl in arylthio may be selected from, for example, aryls having 6 to 12 carbon atoms. The alkyl and the moiety other than a benzene ring in the aryl may be linear, branched or cyclic.

In this invention, it is preferable to use a polycarbazole compound having a unit structure represented by formula (4) or (5), and it is more preferable to use a polycarbazole compound having a unit structures represented by formulas (4) and a unit structure represented by formula (5):

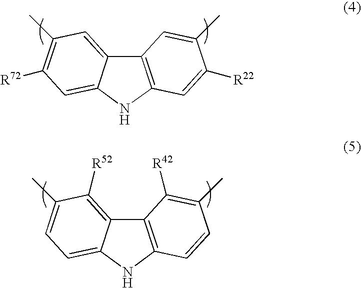

wherein R²², R⁷², R⁴² and R⁵² are independently selected from the group consisting of halogen, hydroxyl, carboxyl, sulfonic, nitro, cyano, alkyl, aryl, alkoxy, amino, alkylthio and arylthio. Preferably R²², R⁷², R⁴² and R⁵² are independently selected from the group consisting of carboxyl, cyano and halogen. The alkyl and the alkyl in alkoxy or alkylthio may be selected from, for example, alkyls having 1 to 6 carbon atoms. The aryl and the aryl in arylthio may be selected from, for example, aryls having 6 to 12 carbon atoms. The alkyl and the moiety other than a benzene ring in the aryl may be linear, branched or cyclic.

A polycarbazole compound used in this invention may have one or more other unit structures as long as it is a polymer compound having a unit hstructure derived from carbazole or its derivative used as a monomer. Examples of a monomer to be another unit structure include indole and indole derivatives, and aniline and aniline derivatives. The number of unit structures derived from carbazole or its derivative is preferably 20% or more of the total number of unit structures in a polycarbazole compound.

In the light of easier synthesis and reduction in solubility in an electrolyte solution at a high temperature, a polycarbazole compound used in this invention preferably has a number average molecular weight of 2,000 to 30,000, more preferably 5,000 to 15,000. A number average molecular weight can be determined by gel permeation chromatography.

In the light of improving handling properties and cycle properties at a high temperature, a polycarbazole compound used in this invention preferably has a thermal decomposition temperature of 300 to 500° C., more preferably 400 to 500° C. A thermal decomposition temperature herein is defined as a temperature at an intersection of extrapolation lines for thermal weight reduction ratio before and after initiation of thermal decomposition (see FIG. 2), and thermogravimetric measurement is effected in the air at heating rate of 10° C./min.

There will be described a synthetic process for a polycarbazole compound.

A polycarbazole compound can be suitably synthesized by electrolytically polymerizing carbazole or its derivative as a monomer in a solution containing an electrolyte. For example, an appropriately selected monomer is dissolved to 20 mmol/L in acetonitrile containing 0.3 mol/L of lithium tetrafluoroborate as an electrolyte. The solution is subjected to electrolytic polymerization under the conditions of a potential sweeping range of 500 mV to 1600 mV and a potential sweeping speed of 50 mV/s using a potentiostat, to precipitate a polymer on a working electrode. By washing the precipitate with ethanol, a polycarbazole compound can be obtained as a powder or film.

Examples of a solvent used in the electrolytic polymerization may include, in addition to acetonitrile described above, aromatic hydrocarbons such as toluene, xylenes and chlorobenzene; halogenated aliphatic hydrocarbons such as dichloromethane and chloroform; acetates such as methyl acetate, ethyl acetate and butyl acetate; aprotic polar solvents such as dimethylformamide, dimethylacetamide, N-methylpyrrolidone, tetramethylurea and hexamethylphosphoric triamide (HMPA); ether solvents such as diethyl ether, tetrahydrofuran and dioxane; aliphatic hydrocarbons such as pentane and n-hexane; aliphatic alcohols such as methanol, ethanol, n-propanol, isopropanol, n-butanol, sec-butanol and tert-butanol; acetone; and propionitrile. Among others, preferred are acetone, acetonitrile, dioxane and dimethylformamide. These solvents may be used alone or in combination of two or more appropriately selected in. a given proportion.

Examples of an electrolyte used in the electrolytic polymerization include, in addition to lithium tetrafluoroborate described above, perchloric acid, lithium perchlorate, sodium perchlorate, tetrabutylammonium perchlorate, tetraethylammonium perchlorate, tetraethylammonium tetrafluoroborate and tetrabutylammonium tetrafluoroborate. Among others, preferred are lithium tetrafluoroborate, tetraethylammonium tetrafluoroborate and tetrabutylammonium tetrafluoroborate. These electrolytes may be used alone or in combination of two or more appropriately selected in a given proportion.

An electrolyte concentration in a solution containing the electrolyte is preferably within the range of 0.025 to 6.0 mol/L.

In electrolytic polymerization, a monomer concentration in a solution is preferably within the range of 0.005 to 0.2 mol/L. A ratio of an electrolyte to a monomer is preferably 5 to 30 mol of the electrolyte to 1 mol of the monomer. When synthesizing a polycarbazole compound having another unit structure, an electrolytic polymerization may be effected in the presence of a monomer to be the unit structure.

The conditions of electrolytic polymerization may be selected as appropriate. For example, in terms of a potential sweeping range, an initial voltage may be 0 to 800 mV-and a terminal voltage may be 1200 to 2000 mV. A potential sweeping speed may be 5 to 100 mV/s. An electrolytic polymerization time depends on a potential sweeping range and a potential sweeping speed described above, but, for example, in the light of reducing by-products, is preferably 0.1 to 10 hours.

Besides the above electrolytic polymerization, a polycarbazole compound may be also synthesized by chemical oxidative polymerization in which carbazole or its derivative as a monomer is dissolved in a solvent and the monomer is oxidized and polymerized in the solution by an oxidizing agent. For example, an appropriately selected monomer is dissolved in acetonitrile as a solvent. To the solution is then added ferric chloride as an oxidizing agent, and the mixture is stirred to precipitate a polymer. The precipitate is filtrated and washed with ethanol to give a polycarbazole compound.

Examples of a solvent used in the chemical oxidative polymerization include, in addition to acetonitrile described above, aromatic hydrocarbons such as toluene, xylenes and chlorobenzene; halogenated aliphatic hydrocarbons such as dichloromethane and chloroform; acetates such as methyl acetate, ethyl acetate and butyl acetate; aprotic polar solvents such as dimethylformamide, dimethylacetamide, N-methylpyrrolidone, tetramethylurea and hexamethylphosphoric triamide (HMPA); ether solvents such as diethyl ether, tetrahydrofuran and dioxane; aliphatic hydrocarbons such as pentane and n-hexane; aliphatic alcohols such as methanol, ethanol, n-propanol, isopropanol, n-butanol, sec-butanol and tert-butanol; acetone; and propionitrile. Among others, preferred are acetone, acetonitrile, dioxane and dimethylformamide. These solvents may be used alone or in combination of two or more appropriately selected in a given proportion.

Examples of an oxidizing agent used in the chemical oxidative polymerization include, in addition to ferric chloride described above, ferric chloride hexahydrate, anhydrous ferric chloride, ferric nitrate nonahydrate, ferric nitrate, ferric sulfate n-hydrate, ammonium ferric sulfate dodecahydrate, ferric perchlorate n-hydrate, ferric tetrafluoroborate, cupric chloride, cupric sulfate, cupric tetrafluoroborate, nitrosonium tetrafluoroborate, ammonium persulfate, sodium persulfate, potassium persulfate, sodium periodate, potassium periodate, hydrogen peroxide, ozone, potassium hexacyanoferrate, cerium (IV) tetraammonium sulfate dihydrate, bromine and iodine. Among others, preferred are ferric chloride hexahydrate, anhydrous ferric chloride, ferric nitrate nonahydrate, ferric nitrate, ferric sulfate n-hydrate, ammonium ferric sulfate dodecahydrate, ferric perchlorate n-hydrate and ferric tetrafluoroborate. These oxidizing agents may be used alone or in combination of two or more appropriately selected in a given proportion.

In the chemical oxidative polymerization, an oxidizing agent concentration is preferably within the range of 0.3 to 50 mol/L.

In the chemical oxidative polymerization, a monomer concentration is preferably within the range of 0.1 to 5.0 mol/L. A ratio of an oxidizing agent to a monomer is preferably 3 to 10 mol of the oxidizing agent to 1 mol of the monomer. When synthesizing a polycarbazole compound having another unit structure, a chemical oxidative polymerization may be effected in the presence of a monomer to be the unit structure.

The conditions of the chemical oxidative polymerization may be adjusted as appropriate. A reaction temperature may be appropriately within, for example, the range of 0° C. to a reflux temperature of a solvent used, but is preferably within the range of 10 to 100° C. A reaction time is preferably, but not limited to, 0.1 to 100 hours in the light of reducing by-products.

Since a polycarbazole compound thus prepared may undergo the following electrode reaction, which is an electrode reaction of a polycarbazole prepared by polymerizing carbazole as an example, it can act as an electrode active material in an electrochemical cell.

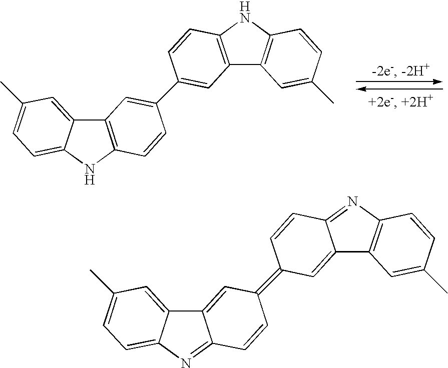

There will be described a configuration of an electrochemical cell according to this invention and a manufacturing process therefor.

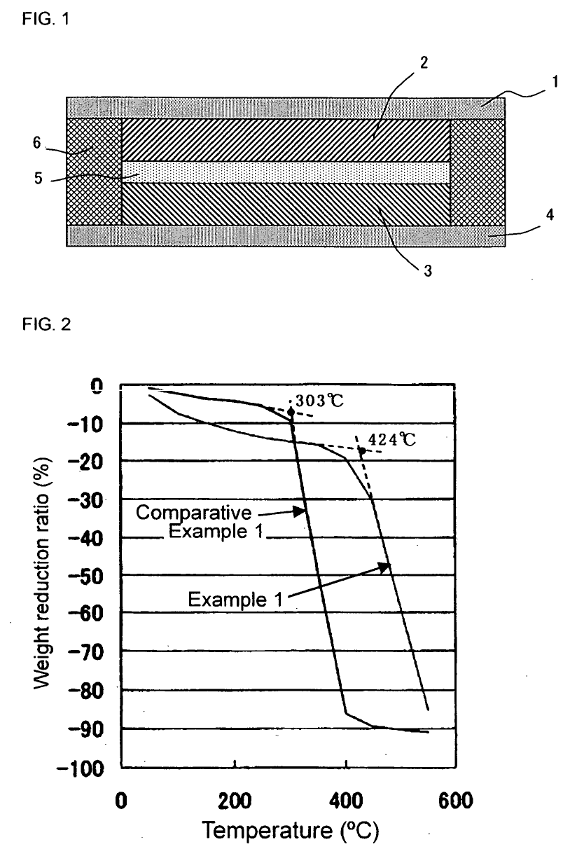

An electrochemical cell according to this invention has a configuration, for example, as shown in the cross-sectional view of FIG. 1, where a cathode collector 1 on which a cathode 2 containing a proton-conducting compound as an active material is formed is laminated with an anode collector 4 on which an anode 3 containing a proton-conducting compound as an active material is formed, via a separator 5 such that the cathode 2 and the anode 3 face each other. In this electrochemical cell, an aqueous or non-aqueous solution containing a proton source as an electrolyte solution fills the insides of the separator 5, cathode 2 and the anode 3, whose outer edges are sealed by a gasket 6. By appropriately selecting the electrode active materials for the cathode 2 and the anode 3, the cell may be a secondary battery or a electric double-layer capacitor.

In this invention, the polycarbazole compound described above is used as electrode active materials for the cathode 2 and/or the anode 3. There will be described, as an example, a secondary battery in which the polycarbazole compound described above is used as an electrode active material for the cathode 2. The above polycarbazole compound may be used as an electrode active material for the anode 3 or as electrode active materials for both cathode 2 and anode 3. Similarly, it may be used in an electric double-layer capacitor.

The cathode 2 can consist of a polycarbazole compound as an electrode active material, a conduction auxiliary and a binder.

Examples of an electrode active material include, in addition to a polycarbazole compound, t-conjugated polymers such as polyaniline, polythiophene, polypyrrole, polyacetylene, poly-p-phenylene, polyphenylene-vinylene, polyperinaphthalene, polyfuran, polyflurane, polythienylene, polypyridinediyl, polyisothianaphthene, polyquinoxaline, polypyridine, polypyrimidine, polyindole, indole derivatives including an indole trimer, polyaminoanthraquinone, polyimidazole and their derivatives; hydroxyl-containing polymers such as polyanthraquinone and polybenzoquinone, of which a quinone oxygen has been converted into a hydroxyl group by conjugation; and proton-conducting polymers prepared by copolymerization of two or more monomers, which can be used alone or in combination of two or more. Here, it is preferable that a content of an electrode active material other than a polycarbazole compound is 50% by weight or less to the total amount of the electrode active materials.

An electrode active material for the cathode 2 can be appropriately selected such that it has a redox potential different by a desired value from that in an electrode active material for the anode 3 as a counter electrode, allowing a desired voltage to be generated.

A conduction auxiliary may be, for example, vapor growth carbon fiber (VGCF), whose amount may be preferably 1 to 50 wt %, more preferably 10 to 30 wt % to an electrode active material. A binder may be, for example, polyvinylidene fluoride (PVDF), whose amount is preferably 1 to 20 wt %, more preferably 5 to 10 wt % to an electrode active material.

A powder prepared by mixing these components can be pressed at 0 to 300° C., preferably 100 to 250° C., to form the cathode 2.

The anode 3 can be formed, for example, by pressing and firing a powdery mixture of polyphenylquinoxaline and Ketjen Black (Ketjenblack International Corporation: EC600JD (trade name)) as a conduction auxiliary in a weight ratio of 90:10 to 50:50.

Besides the pressing described above, the cathode 2 and the anode 3 can be also formed by, for example, deposition by applying a slurry containing appropriate components.

An electrolyte solution may be a proton-containing aqueous or non-aqueous solution; for example, inorganic acids such as sulfuric acid, nitric acid, hydrochloric acid, phosphoric acid, tetrafluoroboric acid, hexafluorophosphoric acid and hexafluorosilicic acid; saturated aliphatic monocarboxylic acids such as formic acid, acetic acid and propionic acid; oxycarboxylic acids such as lactic acid, glyceric acid, tartaric acid and citric acid; and organic acids such as p-toluenesulfonic acid, polyvinylsulfonic acid and lauric acid. Such an organic acid may be dissolved in, for example, acetonitrile, ethylene carbonate, propylene carbonate, dimethylformamide (DMF), N-methylpyrrolidone (NMP) or dimethylsulfoxide (DMSO) to prepare a solution, which can be used as an electrolyte solution. A content of protons is preferably 1×10⁻³ to 18 mol/L, more preferably 1×10⁻¹ to 7 mol/L. If it is less than 1×10⁻³, a proton concentration is so low that reactivity in an electrode tends to be inadequate. If it is more than 18 mol/L, the solution is so acidic that a material such as an electrode active material may be less active and the electrode active material may be eluted into the electrolyte solution.

The separator 5 may be, for example, a polyolefin porous film or cation-exchange film with a thickness of 10 to 50 μm.

An external shape of the electrochemical cell may be, but not limited to, a coin or laminate.

### EXAMPLES

There will be more specifically described this invention with reference to Examples.

### Example 1

In acetonitrile as a solvent were dissolved 2-carboxylic-carbazole as a monomer for synthesizing a polycarbazole compound to 20 mmol/L and lithium tetrafluoroborate as an electrolyte to 0.3 mol/L, and the solution was subjected to electrolytic polymerization using a potentiostat. The conditions of the electrolytic polymerization were as follows; potential sweeping range: 500 mV to 1600 mV and potential sweeping speed: 50 mV/s. After the electrolytic polymerization, a precipitate was observed on a working electrode. The precipitate was washed with ethanol and dried to provide a dark green polycarbazole compound.

A number average molecular weight of the polycarbazole compound prepared was 12,000. FIG. 2 shows the thermogravimetry results for the polycarbazole. It can be seen that a thermal decomposition temperature of the polycarbazole compound is 424° C., which is lower by more than 100° C. than a thermal decomposition temperature, 303° C., of the indole trimer prepared in Comparative Example 1. Thus, it can be presumed that the electrochemical cell exhibits improved thermal stability.

Subsequently, the polycarbazole compound was used to form an electrochemical cell. Specifically, using the polycarbazole compound as an electrode active material for a cathode, the mixture of the electrode active materiaINGCF/PVDF in a weight ratio of 69/23/8 was pressed at 200° C. to form an electrode, which was used as a cathode. In terms of an anode, using polyphenylquinoxaline as an electrode active material for an anode, the composite of the electrode active material/Ketjen Black in a weight ratio of 72/28 was pressed at 300° C. and then fired to form an electrode as an anode. An electrolyte solution was a 20 wt % aqueous solution of sulfuric acid. A separator was a cation-exchange film with a thickness of 15 μm. Then, the cathode and the anode were faced each other via the separator and the product was sealed by a gasket to an electrochemical cell as a coin type secondary battery.

### Example 2

A polycarbazole compound was synthesized as described in Example 1, except that a monomer for preparing the polycarbazole compound was 4-hydroxycarbazole. A number average molecular weight of the polycarbazole compound obtained was 9,500. An electrochemical cell was formed as described in Example 1, except that the polycarbazole compound was used as a cathode active material.

### Example 3

A polycarbazole compound was synthesized as described in Example 1, except that a monomer for preparing the polycarbazole compound was 2,7-diacetylcarbazole. A number average molecular weight of the polycarbazole compound obtained was 6,300. An electrochemical cell was formed as described in Example 1, except that the polycarbazole compound was used as a cathode active material.

### Example 4

A polycarbazole compound was synthesized as described in Example 1, except that a monomer for preparing the polycarbazole compound was 4,5-dibromocarbazole. A number average molecular weight of the polycarbazole compound obtained was 5,500. An electrochemical cell was formed as described in Example 1, except that the polycarbazole compound was used as a cathode active material.

### Example 5

A polycarbazole compound was synthesized as described in Example 1, except that two monomers, 2-carboxylic-carbazole and 4-hydroxycarbazole, were used for preparing the polycarbazole compound in a concentration of 20 mmol/L, respectively, in the solvent. A number average molecular weight of the polycarbazole compound obtained was 10,200. An electrochemical cell was formed as described in Example 1, except that the polycarbazole compound was used as a cathode active material.

### Example 6

A polycarbazole compound was synthesized as described in Example 1, except that two monomers, 2,7-diacetylcarbazole and 4,5-dibromocarbazole, were used for preparing the polycarbazole compound in a concentration of 20 mmol/L, respectively, in the solvent. A number average molecular weight of the polycarbazole compound obtained was 5,200. An electrochemical cell was formed as described in Example 1, except that the polycarbazole compound was used as a cathode active material.

### Comparative Example 1

Using 5-cyanoindole as a monomer, polymerization was conducted as described in Example 1, to prepare an indole trimer compound in which 5-cyanoindole was trimerized. FIG. 2 shows the thermogravimetry results for the indole trimer compound. It can be seen that a thermal decomposition temperature of the indole trimer is 303° C. An electrochemical cell was formed as described in Example 1, except that the indole trimer compound was used as a cathode active material.

Cycle Test

The electrochemical cells thus formed were evaluated by a cycle test at a high temperature. As the cycle test conditions, a cell was charged at a constant current (5 C) and a constant voltage for 10 min, and then discharged at a constant current (1 C) to a discharge depth of 100%. The cycle of charge and discharge was repeated and charge/discharge cycle properties were evaluated. A charge voltage per a base element was 1.2 V and an evaluation temperature was 60° C.

Table 1 shows residual capacity ratios after 5,000 cycles at 60° C. for the electrochemical cells. It can be seen that the electrochemical cells (Examples 1 to 5) using a polycarbazole compound as an electrode active material as in the present invention exhibit improved cycle properties by 8 to 17% in comparison with the electrochemical cell using the indole trimer as an electrode active material (Comparative Example 1).

TABLE 1

| | Residual capacity ratio |
|---|---|
| | (%) after 5,000 cycles |
| Example 1 | 89 |
| Example 2 | 82 |
| Example 3 | 87 |
| Example 4 | 84 |
| Example 5 | 80 |
| Example 6 | 82 |
| Comparative | 72 |
| Example 1 | |

1. An electrochemical cell, comprising a polycarbazole compound prepared by polymerizing carbazole or its derivative as an electrode active material, wherein protons act as a charge carrier.

2. The electrochemical cell as claimed in claim 1, wherein the polycarbazole compound has a unit structure represented by formula (1): 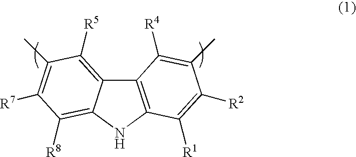
wherein R¹, R², R⁴, R⁵, R⁷ and R⁸ are independently selected from the group consisting of hydrogen, halogen, hydroxyl, carboxyl, sulfonic, nitro, cyano, alkyl, aryl, alkoxy, amino, alkylthio and arylthio.

3. The electrochemical cell as claimed in claim 2, wherein the polycarbazole compound has a unit structure represented by formula (2) or (3): 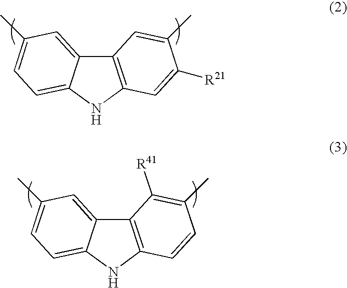
wherein R²¹ and R⁴¹ are independently selected from the group consisting of halogen, hydroxyl, carboxyl, sulfonic, nitro, cyano, alkyl, aryl, alkoxy, amino, alkylthio and arylthio.

4. The electrochemical cell as claimed in claim 3, wherein the polycarbazole compound has two or more of the unit structures represented by formula (2) or (3).

5. The electrochemical cell as claimed in claim 2, wherein the polycarbazole compound has a unit structure represented by formula (4) or (5): 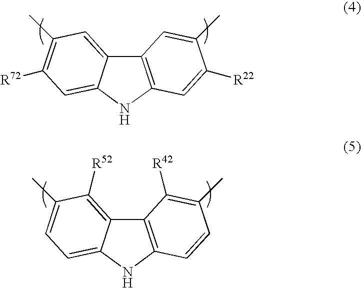
wherein R²², R⁷², R⁴² and R⁵² are independently selected from the group consisting of halogen, hydroxyl, carboxyl, sulfonic, nitro, cyano, alkyl, aryl, alkoxy, amino, alkylthio and arylthio.

6. The electrochemical cell as claimed in claim 5, wherein the polycarbazole compound has the unit structure represented by formula (4) and the unit structure represented by formula (5).

7. The electrochemical cell as claimed in claim 1, wherein an electrolyte solution has a proton concentration of 1×10⁻³ to 18 mol/L.

8. The electrochemical cell as claimed in claim 1, wherein an electrolyte solution is an aqueous electrolyte solution.

9. The electrochemical cell as claimed in claim 1, comprising the polycarbazole compound as a cathode active material.

10. An electrochemical cell of a type wherein protons act as a charge carrier, comprising:
a cathode containing a proton-conducting compound as a cathode active material;
an anode containing a proton-conducting compound as an anode active material; and
a separator interposed between the cathode and the anode,
wherein at least one of the cathode active material or the anode active material is a polycarbazole compound.

11. The electrochemical cell as claimed in claim 10, wherein the polycarbazole compound has a number average molecular weight of 2,000 to 30,000.

12. The electrochemical cell as claimed in claim 10, wherein the polycarbazole compound has a thermal decomposition temperature of 300° C. to 500° C.

13. The electrochemical cell as claimed in claim 10, wherein the separator, the cathode, and the anode contain an aqueous or non-aqueous solution containing a proton source as an electrolyte solution.

14. The electrochemical cell as claimed in claim 13, further comprising a gasket sealing side edges of the separator, the cathode, and the anode.

15. The electrochemical cell as claimed in claim 10, wherein the polycarbazole compound has a repeating unit structure represented by formula (1): 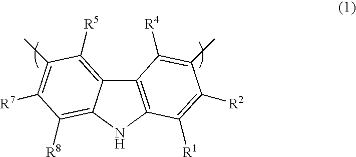
wherein R¹, R², R⁴, R⁵, R⁷ and R⁸ are independently selected from the group consisting of hydrogen, halogen, hydroxyl, carboxyl, sulfonic, nitro, cyano, alkyl, aryl, alkoxy, amino, alkylthio and arylthio.

16. The electrochemical cell as claimed in claim 13, wherein the electrolyte solution has a proton concentration of 1×10⁻³ to 18 mol/L.

17. The electrochemical cell as claimed in claim 13, wherein the electrolyte solution is an aqueous electrolyte solution.

18. The electrochemical cell as claimed in claim 10, wherein only the cathode active material is the polycarbazole compound.
